(19) United States
(12) Patent Application Publication
(10) Pub. No.: US 2026/0298314 A1
(43) Pub. Date: Oct. 1, 2026

(54) COMPACT GEAR TRAIN FOR TURBOMACHINE REDUCER

(71) Applicant: SAFRAN TRANSMISSION SYSTEMS, Colombes (FR)

(72) Inventor: Guillaume Pierre MOULY, Moissy-Cramayel (FR)

(73) Assignee: SAFRAN TRANSMISSION SYSTEMS, Colombes (FR)

(21) Appl. No.: 18/874,508

(22) PCT Filed: Jun. 12, 2023
(86) PCT No.: PCT/FR2023/050845

§ 371 Date: Dec. 12, 2024

(30) Foreign Application Priority Data
Jun. 13, 2022 (FR) FR2205687

(51) Int. Cl. F16H 1/28; F02C 7/36; F02K 3/06

(52) U.S. Cl. CPC F16H 1/2809; F02C 7/36; F02K 3/06; F05D 2260/40311

(57) ABSTRACT

A gear train including a sun gear having a central axis, a ring gear disposed coaxially around the sun gear, a planet carrier, and a first and a second plurality of planet gears. Each planet gear is supported by the planet carrier and includes two first gearings meshed with the ring gear, offset with respect to each other in an axial direction parallel to the central axis. Each planet gear of the first plurality of planet gears includes two second gearings meshed with the sun gear, offset with respect to each other in the axial direction.

### TECHNICAL FIELD

The present disclosure relates to the field of gear trains, and in particular gear trains for a turbomachine mechanical reducer.

### PRIOR ART

Gears are mechanical assemblies in which movement can be transmitted, and possibly transformed, between two meshed solid elements. Their meshing can be ensured by contact, by friction or even by magnetic field, and meshing by contact can normally be ensured using gearings, which can be, for example, straight-cut or inclined or even helical. Gears can be used to transform a rotary movement into a linear movement or vice-versa, for example with a rack gear, but especially for transforming a first rotary movement into a second rotary movement different from the first rotary movement in terms of speed and/or direction of rotation. It is thus possible, in particular, to use at least one gear, or a plurality of connected gears forming a gear train, in a mechanical reducer in order to transform the faster rotation of an input shaft into a slower rotation of an output shaft.

One particular field of use of mechanical reducers is that of turbomachines. More particularly, turbomachines, and in particular gas turbine engines, can have comparatively high speeds of rotation which may need to be reduced for a practical use. Thus, in turbofans, direct driving of the fan by a turbine can limit the maximum diameter of the fan and thus the bypass ratio of the turbofan, since the speed of rotation of the fan with the turbine can be such that transonic speeds are quickly reached at the fan blade tip, even with moderate diameters. It has therefore been proposed to insert a mechanical reducer between a turbine and a fan in order that the fan is rotated at a speed substantially less than that of the turbine driving it. For analogous reasons, mechanical reducers have also been proposed for other turbomachines. Thus in the field of aeronautical propulsion, it is common to incorporate a mechanical reducer between a turbine and a propeller in a turboprop engine, or between a turbine and a lift rotor in a turboshaft engine. The incorporation of a mechanical reducer in a turbomachine is also common in other fields, such as terrestrial or naval propulsion or electrical generation.

In several of these fields, and in particular in the field of aeronautical propulsion, it can be advantageous to have a mechanical reducer that is particularly compact but offers a high reduction ratio. A class of gear trains offering comparatively high reduction ratios with a relatively reduced bulk is that of gear trains with a sun gear, a ring gear disposed coaxially around the sun gear, and a planet carrier with the planet gears meshed with the sun gear and the ring gear, as disclosed for example in the French patent application with publication number FR 2 928 976 A1. In order to provide particularly high reduction ratios, each planet gear can have at least two gearings of different diameters, one meshed with the sun gear and the other with the ring gear. A mechanical reducer for a turbomachine, comprising a gear train with such a configuration has been disclosed, for example, in the publications of European patent application EP 3 726 031 A1 and EP 3 361 122 A1 and in the French patent application with publication number FR 3 008 463 A1.

In such a gear train, it may be advantageous to increase the number of planet gears in order to distribute between them the torque transmitted by the gear train. However, when the radial size of the gear train is restricted, the interference between the planet gears limits their number. In order to avoid this, it has been proposed, in particular in the publication of European patent application EP 1 113 193 A2, to have a first plurality of planet gears and a second plurality of planet gears for which the gearings with largest diameter are axially offset with respect to those of the first plurality of planet gears. However, in this gear train, this requires different cantilevers for the gearings of the two pluralities of planet gears, which can cause bending and torsion torques in the planet gears, and make the balancing of the gear train more difficult.

### DISCLOSURE OF THE INVENTION

A first aspect of the present disclosure relates to a gear train comprising a sun gear having a central axis, a ring gear disposed coaxially around the sun gear, a planet carrier, and a first and a second plurality of planet gears, wherein each planet gear is supported by the planet carrier. Each planet gear may comprise two first gearings meshed with the ring gear. These first gearings of each planet gear can be disposed offset with respect to one another in an axial direction parallel to the central axis. Each planet gear of the first plurality of planet gears can also comprise two second gearings meshed with the sun gear, and each planet gear of the second plurality of planet gears can comprise one or two second gearings meshed with the sun gear. Each of the second gearings of the planet gears of the first and second pluralities of planet gears can have a second median diameter greater than the first median diameter. The two second gearings of each planet gear of the first plurality of planet gears can be offset with respect to each other in said axial direction. In order to enable an interlacing of the second gearings, each second gearing of the second plurality of planet gears can be disposed, in said axial direction, between the second gearings of the first plurality of planet gears.

Thus, through the interlacing of the second gearings, which are those of the largest diameter, it becomes possible to combine a high reduction ratio and a large number of planet gears and therefore a high power transmission capacity of the gear train. Nevertheless, this arrangement also makes it possible to minimise the cantilever and the torsion and bending torques in each planet gear.

In order to facilitate the balancing of the gear train, the two first gearings of each planet gear of the first and second pluralities of planet gears can, in particular, be disposed symmetrically with respect to a transverse plane perpendicular to the central axis, and the two second gearings of each planet gear of the first plurality of planet gears can also be disposed symmetrically with respect to the transverse plane.

At least one planet gear of the second plurality of planet gears can comprise a single second gearing, which is centred on the transverse plane. It is however also possible that at least one planet gear of the second plurality of planet gears comprises two second gearings, which can then be disposed symmetrically with respect to the transverse plane.

The first gearings of the planet gears of the first and second pluralities of planet gears can be straight-cut. In order to enable their correct meshing with the ring gear, this can also have corresponding straight-cut gearings.

Alternatively, however, the first gearings of the planet gears of the first and second pluralities of planet gears can be helical. in this case, in order to balance the axial forces on the planet gears, the first gearings of each planet gear of the first and second pluralities of planet gears can then be inclined in opposite directions. Furthermore, in order to enable their correct meshing with the ring gear, this can also have corresponding helical gearings.

The second gearings of the planet gears of the first plurality of planet gears can also be straight-cut. In order to enable their correct meshing with the sun gear, this can also have straight-cut gearings.

Alternatively, however, the second gearings of the planet gears of the first plurality of planet gears can also be helical. In this case, in order to balance the axial forces on the planet gears, the second gearings of each planet gear of the first plurality of planet gears can be inclined in opposite directions. Furthermore, in order to enable their correct meshing with the sun gear, these can also have corresponding helical gearings.

The second gearings of the planet gears of the second plurality of planet gears can also be straight-cut. In order to enable their correct meshing with the sun gear, this can also have one or two corresponding straight-cut gearings. Furthermore, if the second gearings of the planet gears of the first and second plurality of planet gears are all straight-cut, it is possible that the sun gear comprises a single straight-cut gearing meshed with the second gearings of the planet gears of the first and second plurality of planet gears.

Alternatively, however, the second gearings of the planet gears of the second plurality of planet gears can also be helical. In this case, in order to balance the axial forces on the planet gears, each planet gear of the second plurality of planet gears can comprise two second gearings, inclined in opposite directions. Furthermore, in order to enable their correct meshing with the sun gear, this can also comprise two corresponding helical gearings. It is nevertheless also possible that each planet gear of the second plurality of planet gears comprises a single second herringbone gearing and/or that the sun gear comprises a single herringbone gearing meshed with all the second gearings of the second plurality of planet gears.

Each planet gear of the first and second pluralities of planet gears can be mounted to rotate freely around an axis using a respective bearing, which can in particular be a rolling bearing, although other types of bearing, in particular hydrostatic bearings, are also possible.

Said second median diameter can be greater than a third median diameter which is a median diameter of gearings of the sun gear meshed with the second gearings of each planet gear of the first and second pluralities of planet gears.

A second aspect of the present disclosure relates to a mechanical reducer comprising the gear train according to the first aspect, at least one input shaft mechanically coupled in rotation to one of the sun gear, the ring gear, and the planet carrier, and an output shaft mechanically coupled in rotation to another of the sun gear, the ring gear and the planet carrier.

A third aspect of the present disclosure relates to a turbomachine comprising the mechanical reducer according to the second aspect, at least one turbine and a rotary device, as well as the use of the mechanical reducer according to the second aspect in such a turbomachine. In this turbomachine, the at least one turbine can be mechanically coupled in rotation to the at least one input shaft of the reducer and the rotary device can be mechanically coupled in rotation to the output shaft. In particular, the rotary device can be a fan, in order to form a turbofan comprising a fan with reducer. It is however also possible that the rotary device is a propulsive propeller or a lift rotor, or even a propulsion wheel, a hydraulic transmission or an electrical generator.

### BRIEF DESCRIPTION OF THE DRAWINGS

The object of the present disclosure and its advantages will be better understood on reading the following detailed description of embodiments presented by way of non-limiting examples. This description refers to the attached pages of figures, in which:

FIG. 1 is a schematic representation of a turbomachine with a mechanical reducer.

FIG. 2 schematically represents a mechanical reducer according to a first embodiment.

FIG. 3 is a detailed view of a planet carrier and of a lubricating system of the mechanical reducer of FIG. 2.

FIG. 4 schematically illustrates the orientation of the gearings of the planet gears of the mechanical reducer of FIG. 2.

FIG. 5 schematically illustrates the orientation of the gearings of the planet gears of a mechanical reducer according to a second embodiment.

FIG. 6 illustrates the arrangement of the bearings of the planet gears of the mechanical reducer of FIG. 5.

FIG. 7 schematically illustrates a mechanical reducer according to a third embodiment.

FIG. 8 schematically illustrates the orientation of the gearings of planet gears of the mechanical reducer of FIG. 7.

FIG. 9 schematically illustrates a mechanical reducer according to a fourth embodiment.

FIG. 10 schematically illustrates a turbomachine with a mechanical reducer according to a fifth embodiment.

FIG. 11 schematically illustrates the mechanical reducer according to the fifth embodiment.

### DESCRIPTION OF THE EMBODIMENTS

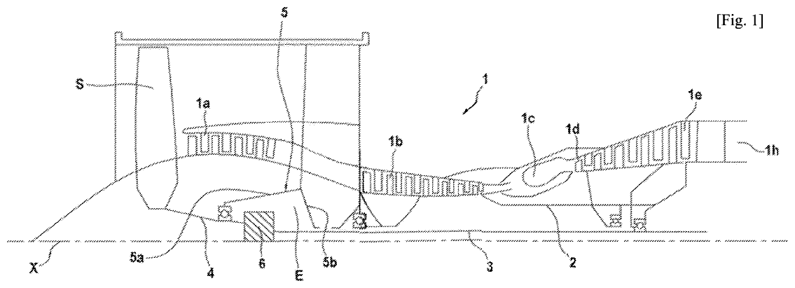

As illustrated in FIG. 1, a turbomachine 1 can take the form of a turbofan comprising, in conventional manner, a fan S, a low-pressure compressor 1a, a high-pressure compressor 1b, a combustion chamber 1c, which may be annular, a high-pressure turbine 1d, a low-pressure turbine 1e and an exhaust nozzle 1h. The high-pressure compressor 1b and the high-pressure turbine 1d can be mechanically connected in rotation by a high-pressure shaft 2, and thus together form a high-pressure (HP) body. The low-pressure compressor 1a and the low-pressure turbine 1e can be mechanically connected in rotation by a low-pressure shaft 3, and thus together form a low-pressure (LP) body.

In order to be driven, the fan S can be constrained to rotate with a fan shaft 4 mechanically connected in rotation to the low-pressure shaft 3 via a mechanical reducer 6. This mechanical reducer 6 can be, for example, planetary, epicyclic or differential. Through this mechanical reducer 6, it is therefore possible to drive the fan S at a speed of rotation less than that of the low-pressure shaft 3, the low-pressure compressor 1a and the low-pressure turbine 1e, thus enabling the fan S to have a larger diameter and to thus provide a higher bypass ratio.

As illustrated in FIG. 1, the reducer 6 can be positioned in a front part of the turbomachine 1, upstream with respect to the low-pressure and high-pressure bodies. Alternative arrangements, disposing the reducer 6 in a rear part, or even an intermediate part of the turbomachine, are however possible. A fixed structure forming an engine casing or stator 5, and able to comprise, as illustrated, an upstream part 5a and a downstream part 5b, can be designed so as to form an enclosure E surrounding the reducer 6. This enclosure E can be, as illustrated, closed upstream by seals at a bearing which can be passed through by the fan shaft 4, and downstream by seals at the passage of the low-pressure shaft 3.

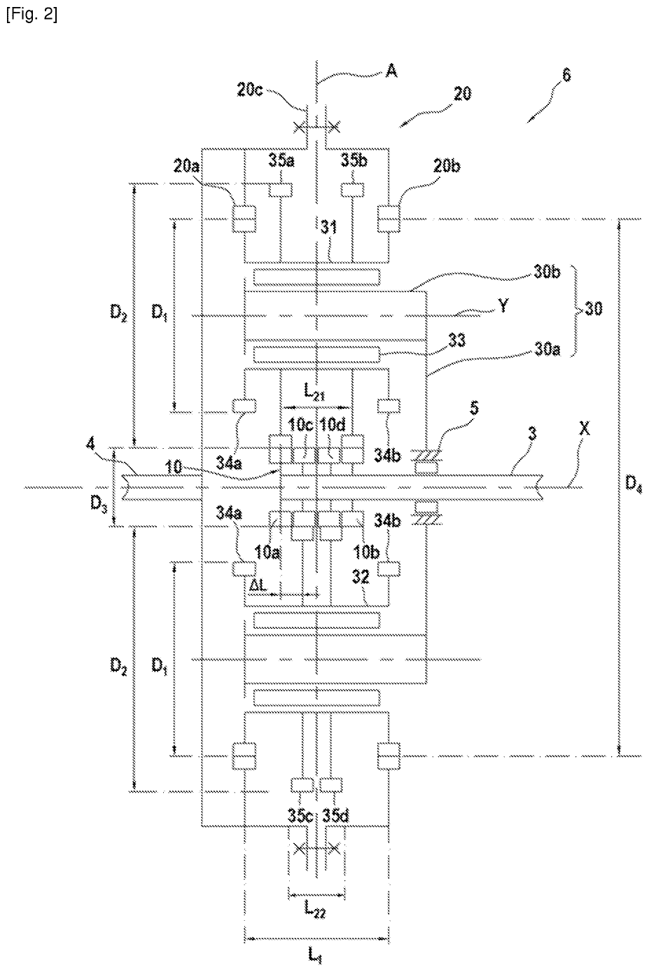

According to a first embodiment, illustrated in FIG. 2, the mechanical reducer 6 can be a planetary reducer with a gear train comprising a sun gear 10 constrained to rotate with the low-pressure shaft 3, a ring gear 20 disposed coaxially around the sun gear 10, with the same central axis X, and constrained to rotate with the fan shaft 4, and a planet carrier 30 integral with the casing 5 and therefore fixed. The common central axis X of the sun gear 10 and the ring gear 20 can be aligned with an axis of rotation of the high-pressure shaft 2 and low-pressure shaft 3. The couplings in rotation between the sun gear 10 and the low-pressure shaft 3 and/or between the ring gear 20 and the fan shaft 4 can therefore be made, for example, by means of splines.

The gear train of the mechanical reducer 6 can also comprise two planet gear assemblies 31, 32 carried by the planet carrier 30 and distributed around the central axis X, for example at substantially identical angular intervals. Each planet gear 31, 32 can be mounted to rotate freely around a corresponding axis Y, able in particular to be substantially parallel to the central axis X, using a respective bearing 33. Each planet gear 31, 32 can comprise two first gearings 34a, 34b, of a first median diameter D₁, meshed with two corresponding gearings 20a, 20b in the ring gear 20. The first gearings 34a, 34b of each planet gear 31, 32 can be offset with respect to each other in the direction of the axis Y, with an axial offset L₁. In particular, in order to ensure good balancing of the forces on the planet gears 31, 32, said first gearings 34a, 34b can have substantially the same width and be disposed symmetrically with respect to a transverse plane of symmetry A.

The planet gears 31 of a first set of planet gears 31 and the planet gears 32 of a second set of planet gears 32 can be disposed alternately around the sun gear 10. Each planet gear 31 of the first set of planet gears 31 can comprise, in addition to the two first gearings 34a, 34b, two second gearings 35a, 35b, with a second median diameter D₂, meshed with the corresponding gearings 10a, 10b of the sun gear 10. The gearings 10a, 10b of the sun gear 10 can have a third median diameter D₃ less than the second median diameter D₂, while the gearings 20a, 20b of the ring gear 20 can have a fourth median diameter D₄ greater than the first median diameter D₁, in order to obtain a reduction ratio between the speeds of rotation of the sun gear 10 and of the ring gear 20. The second median diameter D₂ can be greater than the first median diameter D₁, in such a way as to obtain a higher reduction ratio between the speeds of rotation of the sun gear 10 and of the ring gear 20. The second gearings 35a, 35b of each planet gear 31 of the first set of planet gears 31 can also be offset with respect to each other in the direction of the axis Y. In particular, in order to ensure good balancing of the forces on the planet gears 31, said second gearings 35a, 35b can also have substantially the same width and be disposed symmetrically with respect to the transverse plane of symmetry A with, between them, an axial offset L₂₁ less than the axial offset L₁ between the first gearings 34a, 34b, so as to be disposed between these first gearings 34a, 34b.

In this first embodiment, each planet gear 32 of the second set of planet gears 36 can also comprise, in addition to the two first gearings 34a, 34b, two second gearings 35c, 35d with the same second median diameter D₂. Like the second gearings 35a, 35b of the planet gears 31 of the first set, the second gearings 35c, 35d of the planet gears 32 of the second set can also be meshed with of the corresponding gearings 10c, 10d of the sun gear 10. The second gearings 35c, 35d of each planet gear 32 of the second set of planet gears 32 can also be offset with respect to each other in the direction of the axis Y. In particular, in order to ensure good balancing forces on the planet gears 31, said second gearings 35c, 35d of each planet gear 32 of the second set of planet gears 32 can also have the same width and be disposed symmetrically with respect to the transverse plane of symmetry A. However, the axial offset L₂₂ between the two second gearings 35c, 35d of each planet gear 32 of the second set of planet gears 32 can be less than not only the axial offset L₁ between the first gearings 34a, 34b, but also than the axial offset L₂₁ between the second gearings 35a, 35b of each planet gear 31 of the first set of planet gears 31, in such a way that the second gearings 35c, 35d of the planet gears 32 of the second set of planet gears 32 are disposed, in axial direction, between the second gearings 35a, 35b of the planet gears 31 of the first set of planet gears. It is thus possible to obtain, between the second gearings 35a, 35b of the planet gears 31 of the first set and the second gearings 35c, 35d of the planet gears 32 of the second set, an axial offset ΔL, equal to half the difference between the axial offsets L₁ and L₂, which makes it possible to approach the axes Y of the planet gears 31, 32 of the two assemblies, without collision between the second gearings 35a-35d of adjacent planet gears 31, 32, and therefore to distribute the mechanical load between a larger number of planet gears 31, 32 with a restricted radial size.

In order to facilitate the mounting of the mechanical reducer 6, the ring gear 20 can comprise two parts, each integral with one of the gearings 20a, 20b, which can be fixed to one another by a flange 20c able to be substantially aligned with the transverse plane of symmetry A.

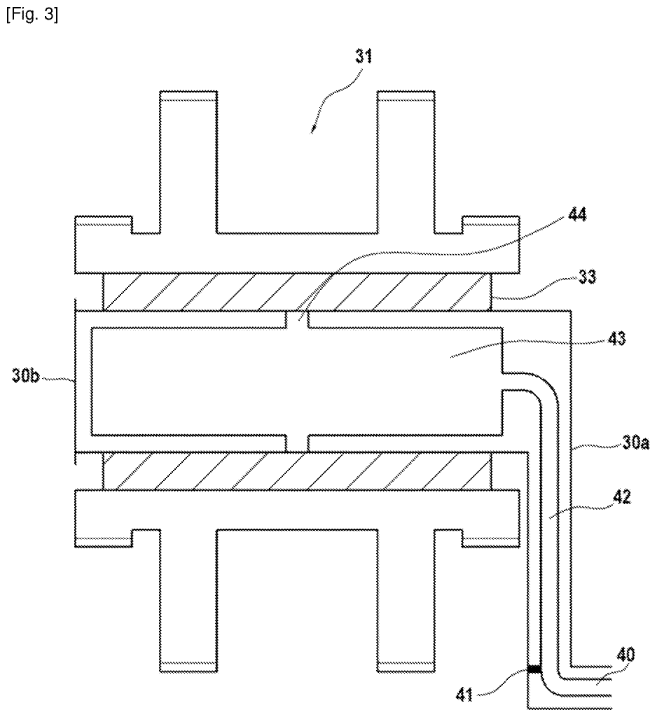

As illustrated in detail in FIG. 3, each bearing 33, which can be, for example, a rolling bearing or hydrostatic bearing, can be mounted on an axis 30b of the planet carrier 30, in such a way that each planet gear, 31 or 32, is internally supported around one of the axes 30b by the corresponding bearing 33. In this case, all the axes 30b of the planet carrier 30 can be positioned with respect to one another using one or more structural chassis 30a of the planet carrier 30. For reasons of operation, assembling, manufacturing, control, repair and/or replacement, the axes 30b and the chassis 30a of the planet carrier 30 can be separable into several parts. In order to provide the lubrication of the reducer 6, the latter can comprise a lubricating fluid distributor 40 with injectors 41 for lubricating the gears and arms 42 opening, through buffer cavities 43 in the axes 30b of the planet gear carrier, on supply ports 44 of the bearings 33 in order to lubricate the latter. A lubricating fluid can therefore follow the path illustrated by the arrows of FIG. 3 in order to lubricate bearings and gears.

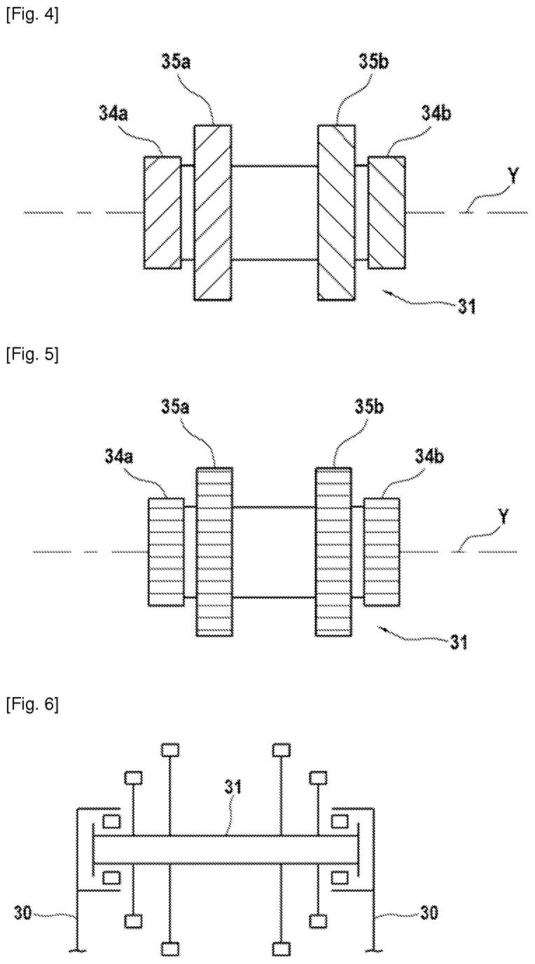

In this first embodiment, the gearings can be helical gearings. As illustrated in FIG. 4, the two first gearings 34a, 34b of each planet gear 31, 32 can be inclined in opposite directions, in particular symmetrically, in order to obtain a balance of axial forces in each planet gear 31, 32. Consequently, in order to obtain correct meshing, the corresponding gearings 20a, 20b in the ring gear 20 can have the same inclinations. Analogously, the two second gearings 35a-35d of each planet gear 31, 32 can also be inclined in opposite directions, in particular symmetrically, in order to obtain a balance of axial forces in each planet gear 31, 32. Consequently, in order to obtain correct meshing, the corresponding gearings 10a-10d in the sun gear 10 can have the same inclinations.

It is nevertheless also possible that at least some of all these gearings are straight-cut gearings. Thus, in a second embodiment, illustrated in FIG. 5, all of the gearings 34a, 34b and 35a-35d of each planet gear 31, 32 can be straight-cut gearings, just as for the corresponding gearings on the sun gear 10 and in the ring gear 20. In this case, the four corresponding gearings on the sun gear 10 could be replaced by a single through gearing 10a of sufficient width to mesh with the second gearings 35a-35d of each planet gear 31, 32. It is also possible that the planet gears 31 and 32 are supported at their axial ends by external bearings 33, as illustrated in FIG. 6, rather than by internal bearings, as in the first embodiment. In this second embodiment, the other elements of the reducer 6 can be identical, or at least equivalent, to those of the first embodiment and also arranged in the same manner or in an analogous manner. Consequently, they receive the same reference signs in FIGS. 5 and 6 as in the preceding figures.

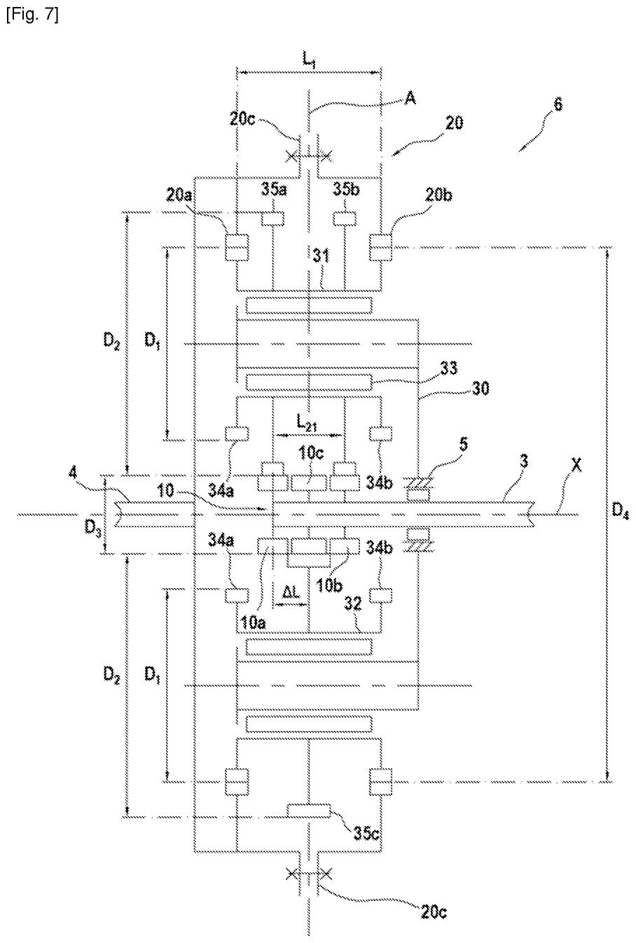

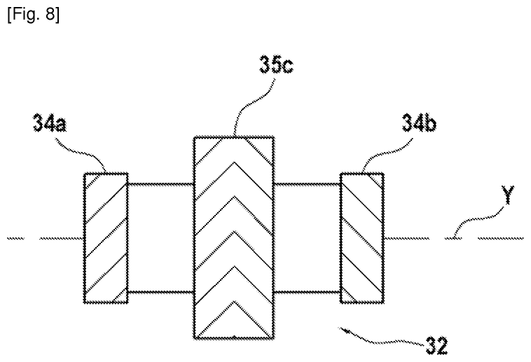

Since the two second gearings of each planet gear of the second set are adjacent, it is also possible, in a third embodiment illustrated in FIG. 7, to replace them by a single second gearing 35c, which can be produced in a single piece, centred on the transverse plane of symmetry A and the width of which could be substantially equal to the sum of the widths of the second gearings 35a, 35b of the planet gears 31 of the first set. In this case, this second gearing 35c of each planet gear 32 can be herringbone, as illustrated in FIG. 8. Alternatively, however, it could be a straight-cut gearing, as in the second embodiment. As illustrated in FIG. 7, the second gearings 35c of the planet gears 31 of this third embodiment could be meshed on a single corresponding gearing 10c on the sun gear 10. In this third embodiment, the other elements of the reducer 6 can also be identical or at least equivalent to those of the preceding embodiments and also arranged in the same manner or in an analogous manner. Consequently, they receive the same reference signs in FIGS. 7 and 8 as in the preceding figures.

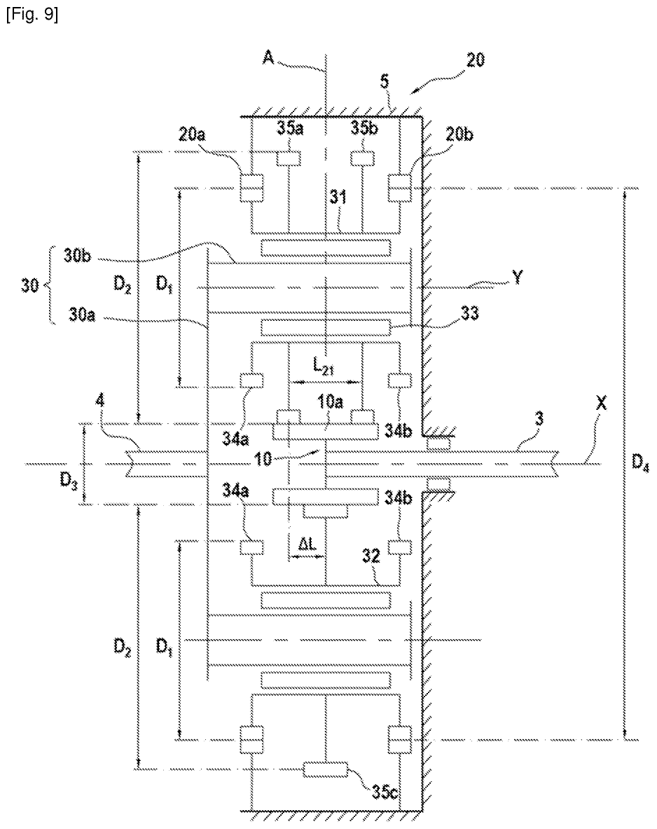

Although, in these three first embodiments, the gear train is a planetary gear train, in which the planet carrier 30 is fixed, it is also possible that the mechanical reducer 6 comprises instead an epicyclic gear train, in which the ring gear 20 is integral with the casing 5 and therefore fixed, and the planet carrier 30 is integral with the rotating fan shaft 4, as in the fourth embodiment illustrated in FIG. 9. In this fourth embodiment, the other elements of the reducer 6 can also be identical or at least equivalent to those of the preceding embodiments and also arranged in the same manner or in an analogous manner. Consequently, they receive the same reference signs in FIG. 9 as in the preceding figures.

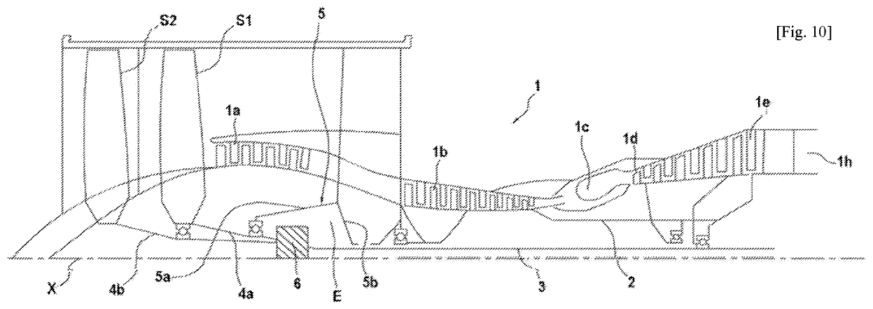

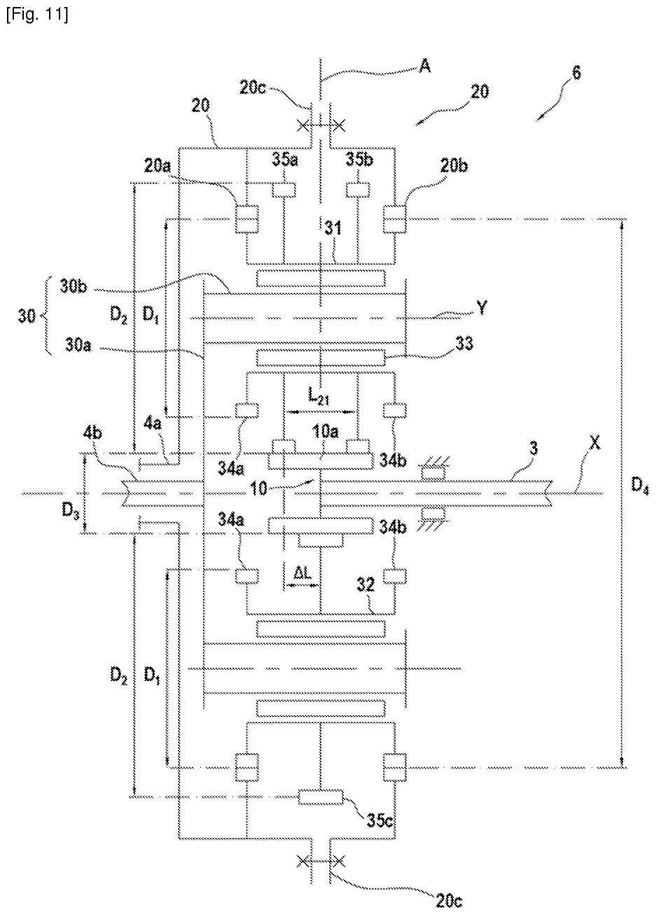

Furthermore, it is also possible, in particular for a turbomachine 1 with a fan S with counter-rotating blades S1, S2, that the gear train is a differential gear train. As illustrated in FIGS. 10 and 11, the sun gear 10 could then be constrained to rotate with the low-pressure shaft 3, the ring gear 20 of a first fan shaft 4a, and the planet gear carrier 30 of a second counter-rotating fan shaft 4b. In addition, in this fifth embodiment, the other elements of the reducer 6 can also be identical or at least equivalent to those of the preceding embodiments and also arranged in the same manner or in an analogous manner. Consequently, they receive the same reference signs in FIGS. 10 and 11 as in the preceding figures.

Although the present invention has been described by referring to specific embodiments, it is obvious that modifications and changes can be made to these examples without going beyond the general scope of the invention as defined by the claims. In particular, individual features of the various illustrated and/or mentioned embodiments, such as for example straight-cut gearings and/or the external bearings of the planet gears of the second embodiment and the general architectures of the following embodiments, can be combined in additional embodiments. Consequently, the description and the drawings should be considered as illustrating rather than limiting.

1. A gear train for a mechanical reducer for a turbomachine, said gear train comprising:
a sun having a central axis,
a ring gear disposed coaxially around the sun gear,
a planet carrier, and
a first and a second plurality of planet gears, wherein each planet gear is supported by the planet carrier and comprises two first gearings meshed with the ring gear, offset with respect to each other in an axial direction parallel to the central axis,
each planet gear of the first plurality of planet gears comprising two second gearings meshed with the sun gear, offset with respect to each other in said axial direction,
each planet gear of the second plurality of planet gears comprising one or two second gearings meshed with the sun gear, each of the first gearings of the first and second pluralities of planet gears having a first median diameter, and each of the second gearings of the first and second pluralities of planet gears having a second median diameter greater than the first median diameter, and
wherein each second gearing of the second plurality of planet gears being disposed, in said axial direction, between the second gearings of the first plurality of planet gears.

2. The gear train according to claim 1, wherein the two first gearings of each planet gear of the first and second pluralities of planet gears are disposed symmetrically with respect to a transverse plane perpendicular to the central axis, and the two second gearings of each planet gear of the first plurality of planet gears are also disposed symmetrically with respect to the transverse plane.

3. The gear train according to claim 2, wherein at least one planet gear of the second plurality of planet gears comprises a single second gearing, which is centered on the transverse plane.

4. The gear train according to claim 2, wherein at least one planet gear of the second plurality of planet gears comprises two second gearings, disposed symmetrically with respect to the transverse plane.

5. The gear train according to claim 1, wherein the first gearings of the planet gears of the first and second pluralities of planet gears, the second gearings of the planet gears of the first plurality of planet gears, and/or the second gearings of the planet gears of the second plurality of planet gears are straight-cut.

6. The gear train according to claim 1, wherein the first gearings of the planet gears of the first and second pluralities of planet gears, the second gearings of the planet gears of the first plurality of planet gears, and/or the second gearings of the planet gears of the second plurality of planet gears are helical.

7. The gear train according to claim 6, wherein the first gearings of each planet gear of the first and second pluralities of planet gears the second gearings of each planet gear of the first plurality of planet gears, and/or two second gearings of each planet gear of the second plurality of planet gears are inclined in opposite directions.

8. The gear train according to claim 1, wherein each planet gear of the first and second pluralities of planet gears is mounted to rotate freely about a corresponding axis using a respective bearing.

9. The gear train according to claim 1, wherein said second median diameter is greater than a third median diameter which is a median diameter of gearings of the sun gear meshed with the second gearings of each planet gear of the first and second pluralities of planet gears.

10. A mechanical reducer for a turbomachine comprising the gear train according to claim 1, at least one input shaft mechanically coupled in rotation to one of the sun gear, the ring gear and the planet carrier, and an output shaft mechanically coupled in rotation to another of the sun gear, the ring gear and the planet carrier.

11. A turbomachine comprising the mechanical reducer according to claim 10, at least one turbine and a rotary device, wherein the at least one turbine is mechanically coupled in rotation to the at least one input shaft of the mechanical reducer and the rotary device is mechanically coupled in rotation to the output shaft.

12. The turbomachine according to claim 11, wherein the rotary device is a fan.
